(19) United States
(12) Patent Application Publication
(10) Pub. No.: US 2004/0223203 A1
(43) Pub. Date: Nov. 11, 2004

(54) Laser scanning device

(75) Inventors: Toshio Kasai, Tokyo (JP); Tadashi Minakuchi, Saitama-ken (JP); Shoji Iwazaki, Tokyo (JP); Hiroto Watanabe, Tokyo (JP); Tadaaki Suda, Saitama-ken (JP); Hiroyuki Basho, Saitama-ken (JP); Nobuyuki Hori, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/776,179

(22) Filed: Feb. 12, 2004

(30) Foreign Application Priority Data
Feb. 14, 2003 (JP) 2003-036616

(51) Int. Cl. G02B 26/08

(52) U.S. Cl. 359/205

(57) ABSTRACT

A laser scanning device is provided with a laser source which emits a laser beam, a deflector which dynamically deflects the laser beam emitted by the laser source, the laser beam scanning in a main scanning direction within a predetermined angular area, a photodetector which receives light and output electronic signal corresponding to the received light, and a sensor lens arranged to receive the laser beam scanning at a predetermined scanning range, the sensor lens having power at least in the main scanning direction, the sensor lens converging the incident laser beam on the photodetector, the sensor lens having width in the main scanning direction varying in the auxiliary scanning direction.

### BACKGROUND OF THE INVENTION

The present invention relates to a laser scanning device, and in particular, to a laser scanning device that is provided with a detector for detecting misalignment of the laser beam in an auxiliary scanning direction.

Laser scanning devices for scanning a laser beam on a photosensitive body (e.g., photoconductive drum) for forming a two-dimensional image (e.g. electrostatic latent image) thereon are widely used for electrophotographic laser beam printers, digital photocopiers, laser fax machines, laser plotters, and the like. In such laser scanning devices, the laser beam is scanned on the photosensitive body in a predetermined direction (i.e., a main scanning direction), and at the same time, the photosensitive body is moved in a direction perpendicular to the main scanning direction (i.e., in the auxiliary scanning direction).

Typically, the main scanning is realized by dynamically deflecting the laser beam on the photosensitive body in the main scanning direction with use of a deflecting system such as a polygonal mirror or a galvanometer mirror, and the auxiliary scan is realized by moving the photosensitive body in the auxiliary scanning direction so that the main scan position of the laser beam on the photosensitive body will move in the auxiliary scanning direction. In order to draw a desired two-dimensional image on the photosensitive body precisely, the timing of the main scanning of the laser beam has to be controlled properly while precisely adjusting the main scanning position in the auxiliary scanning direction. In conventional techniques, the main scanning timing is generally controlled based on timing of a signal outputted by a photo detector which is placed to receive part of the scanning laser beam. Meanwhile, the scan position in the auxiliary scanning direction is controlled by letting a photodetector receive part of the scanned laser beam and obtaining the scan position in the auxiliary scanning direction from the photodetector's beam reception position in a direction equivalent to the auxiliary scanning direction.

FIG. 9 is a schematic perspective view showing an example of a laser scanning device disclosed in Japanese Patent Provisional Publication No. 2002-23082. A laser beam LB emitted by a laser source 101 is dynamically deflected and scanned in the main scanning direction by a polygonal mirror 102 revolving at high speed. The dynamically deflected laser beam LB is incident on a photosensitive drum 105 via an fθ lens 103 and a bend mirror 104, by which a beam spot formed by the laser beam LB on the surface of the photosensitive drum 105 is scanned in the main scanning direction at a constant speed. The laser beam LB scanning in the main scanning direction is also scanned in the auxiliary scanning direction by rotating the photosensitive drum 105 about its rotation axis. By the main scanning and auxiliary scanning of the laser beam LB which has been modulated according to image data, an electrostatic latent image corresponding to a desired image is formed on the surface of the photosensitive drum 105.

Meanwhile, the dynamically deflected laser beam LB is also reflected by a first mirror 106 which is placed outside a scanning range for the photosensitive drum 105 and is received and detected by a first photodetector 107. Timing for the main scanning of the laser beam LB on the photosensitive drum 105 (main scan timing) is controlled by a control circuit 108 based on a reception signal supplied from the first photodetector 107. Meanwhile, the laser beam LB is also reflected by a second mirror 109 and is received and detected by a second photodetector 110. The position (misalignment) of the laser beam LB in the auxiliary scanning direction is detected based on a signal outputted by the second photodetector 110, by which the position of the laser source 101 in the auxiliary scanning direction is corrected.

FIGS. 10A and 10B are a schematic diagram and a signal waveform diagram showing a principle for detecting the misalignment of the laser beam in the auxiliary scanning direction. In this example, a photodetector 110 for detecting the laser beam position (misalignment) in the auxiliary scanning direction includes a plurality of photodetector surfaces 111 114 which are placed to cover several main scanning position ranges varying in the auxiliary scanning direction as shown in FIG. 10A. In FIG. 10A, the horizontal and vertical directions “H” and “V” correspond to the main scanning direction and the auxiliary scanning direction of the laser beam, respectively.

The first photodetector surface 111 is patterned to extend in the auxiliary scanning direction so as to cover all possible main scanning positions. The second through fourth photodetector surfaces 112-114 (shorter than the first photodetector surface 111) are patterned to be gradually apart from the first photodetector surface 111 in the main scanning direction while covering particular main scan position ranges varying in the auxiliary scanning direction.

By the arrangement of the photodetector surfaces 111-114 in the photodetector 110, when the laser beam position in the auxiliary scanning direction (main scan position) shifts or deviates as V1, V2 and V3 shown in FIG. 10A, different signals are outputted by the photodetector surfaces 111-114 as shown in FIG. 10B. Therefore, by detecting the interval of signals from the photodetector surfaces, the main scan position of the laser beam LB in the auxiliary scanning direction can be detected and thereby the deviation or misalignment of the laser beam LB (main scanning position) in the auxiliary scanning direction from a standard main scanning position can be detected.

However, the above photodetector for detecting misalignment in the auxiliary scanning direction requires the first through fourth photodetector surfaces arranged in the main scanning direction at preset intervals, involving complexity of the structure and high manufacturing cost of the photodetector. Further, the need of large photoreceiving area results in upsizing of the photodetector. Especially when the misalignment in the auxiliary scanning direction has to be detected finely and precisely, a lot of photodetector surfaces have to be arranged in the main scanning direction and the complication and upsizing of the structure become formidable. Numbers of wires connected to the photodetector for drawing signals from the photodetector surfaces and a circuit for processing the outputs of the photodetector surfaces also become necessary, by which the circuitry is necessitated to be large and complicated. As a result, downsizing and cost reduction of the laser scanning device (needing the photodetector for detecting misalignment in the auxiliary scanning direction) becomes difficult.

In order to resolve the above problems, the laser scanning device of the above patent document (Japanese Patent Provisional Publication No. 2002-23082) reduces the number of photodetector surfaces to one, by employing a single photodetector surface extending in the auxiliary scanning direction and a plurality of deflecting elements (mirrors) arranged like the photodetector surfaces 111-114 of FIG. 10A. Each deflecting element is placed to deflect (reflect) the incident laser beam to the photodetector surface. The dynamically deflected laser beam can reach the photodetector surface when it is incident on and deflected by one of the deflecting elements, by which signals like those shown in FIG. 10B are output by the photodetector and thereby the laser beam misalignment in the auxiliary scanning direction is detected. However, the laser scanning device of the document, while reducing the number of photodetector surfaces to one, still requires a plurality of deflecting elements arranged properly and consequently, the simplification, downsizing and cost reduction of the misalignment detection mechanism and the laser scanning device are still difficult. While the patent document also proposes other composition of the misalignment detection mechanism that reduces the number of deflecting elements to one by placing a curved screening element (having a narrow opening formed obliquely) in front of a single deflecting element, the composition is still complex and the downsizing and cost reduction of the laser scanning device can not be attained satisfactorily.

### SUMMARY OF THE INVENTION

The present invention is advantageous in that, there is provided an improved laser scanning device capable of realizing its downsizing and cost reduction by employing a further simplified and miniaturized mechanism for detecting the laser beam misalignment in the auxiliary scanning direction.

According to an aspect of the invention, there is provided a laser scanning device, which is provided with a laser source which emits a laser beam, a deflector which dynamically deflects the laser beam emitted by the laser source, the laser beam scanning in a main scanning direction within a predetermined angular area, a photodetector which receives light and outputs an electronic signal corresponding to the received light, and a sensor lens arranged to receive the laser beam scanning at a predetermined scanning range, the sensor lens having power at least in the main scanning direction, the sensor lens converging the incident laser beam on the photodetector, the sensor lens having width in the main scanning direction varying in the auxiliary scanning direction.

According to the laser scanning device, the misalignment of the laser beam in the auxiliary scanning direction can be detected by simply placing a sensor lens in front of an ordinary photodetector. Therefore, the composition of the detector (misalignment detection mechanism) can be simplified and thereby the downsizing and cost reduction of the laser scanning device can be realized.

Optionally, the sensor lens may be formed to be asymmetrical in the auxiliary scanning direction.

The width of the sensor lens in the main scanning direction may vary stepwise depending on a position in the auxiliary scanning direction. Alternatively, the width of the sensor lens in the main scanning direction varies continuously depending on a position in the auxiliary scanning direction. For example, the sensor lens is formed in a triangle-like shape whose oblique sides are tilted in the main scanning direction relative to a photosensitive surface of the photodetector.

Further optionally, the sensor lens may be configured to converge the laser beam only in the main scanning direction on the photodetector.

In a particular case, the sensor lens may be formed as a part of a cylindrical lens.

In this case, photodetector may have a light receiving area elongated in the auxiliary scanning direction.

Optionally, a length of the light receiving area of the photodetector in the auxiliary scanning direction may be substantially equal to the length of the sensor lens in the auxiliary scanning direction.

Alternatively, the sensor lens may be configured to converge the laser beam both in the main scanning direction and in the auxiliary scanning direction on the photodetector.

In this case, photodetector may have a light receiving area elongated in the auxiliary scanning direction. Further, the length of the light receiving area in the auxiliary scanning direction can be shorter than the length of the sensor lens in the auxiliary scanning direction.

Optionally, the sensor lens may be configured to converge the laser beam on a substantially predetermined position regardless of a position of the incident laser beam.

In a particular case, the sensor lens is formed as a part of a convex lens.

Optionally, the photodetector may have a light receiving surface only for receiving the laser beam converged on the predetermined position.

Still optionally, the photodetector may be configured to serve also as a photodetector for outputting a main scanning timing signal which indicates timing of main scan of the laser beam in the main scanning direction.

Further optionally, the laser source may be mounted on the laser scanning device so that position of its optical axis can be shifted in the auxiliary scanning direction.

### BRIEF DESCRIPTION OF THE ACCOMPANYING DRAWINGS

FIG. 1 schematically shows a perspective view showing main elements of a laser scanning device in accordance with a first embodiment of the present invention;

FIG. 2 is a perspective view showing an exemplary structure of a light source unit of the laser scanning device shown in FIG. 1;

FIGS. 3A and 3B are a front view and a vertical sectional view of a laser diode (as a laser source) mounted on the laser scanning device shown in FIG. 1;

FIGS. 4A and 4B schematically show perspective views of a photodiode (as a photodetector) and a sensor lens of the laser scanning device shown in FIG. 1;

FIG. 5 is a top view for explaining a positional relationship between the sensor lens and the photodiode for detecting misalignment of a laser beam in the auxiliary scanning direction;

FIGS. 6A through 6F are front views and signal waveform diagrams for explaining the detection of the misalignment in the auxiliary scanning direction according to the first embodiment;

FIGS. 7A through 7E are front views of other examples of the sensor lens applicable to the laser scanning device according to the first embodiment;

FIGS. 8A and 8B schematically show perspective views of a photodiode (as a photodetector) and a sensor lens of a laser scanning device in accordance with a second embodiment of the present invention;

FIG. 9 is a perspective view showing an example of a conventional laser scanning device; and

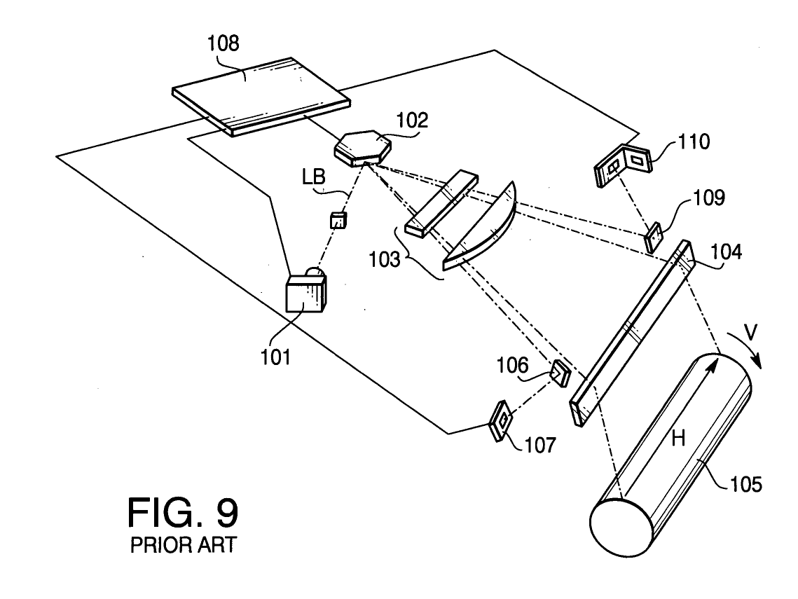

FIGS. 10A and 10B show a configuration and a signal waveform diagram illustrating a principle for detecting the misalignment of the laser beam in the auxiliary scanning direction according to conventional art.

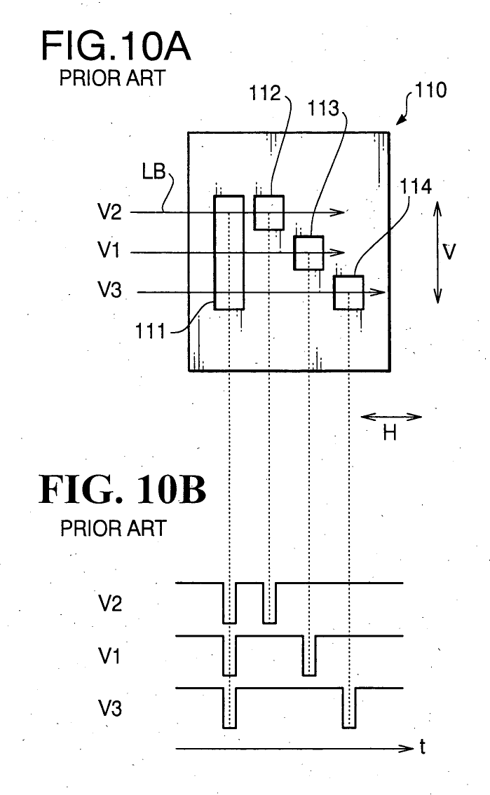

### DESCRIPTION OF THE EMBODIMENTS

Referring now to the drawings, a description will be given in detail of preferred embodiments in accordance with the present invention.

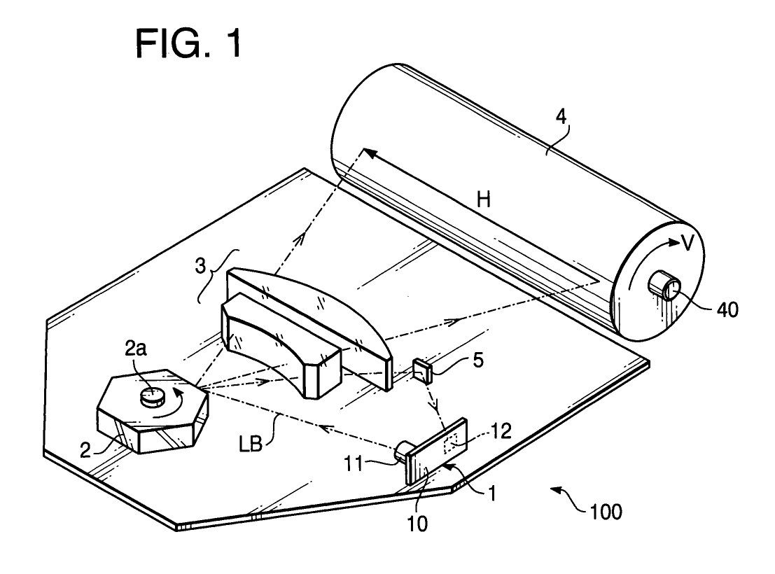

FIG. 1 is a schematic perspective view showing the composition of a laser scanning device 100 according to a first embodiment of the present invention.

A laser beam LB emitted by a laser diode 11 (as a laser source) is incident on a reflecting surface of a polygonal mirror 2 which is formed in the shape of a polygonal prism (e.g. hexagonal prism) viewed from the above. The polygonal mirror 2 is revolved horizontally at high speed about its rotation axis 2a and thereby the incident laser beam LB is dynamically deflected in the main scanning direction (direction H shown in FIG. 1, which is parallel to a rotation axis 4a of a photosensitive drum 4) to scan within a predetermined angular area. The laser beam LB, passing through an fθ lens 3 for adjusting the deflection of the dynamically deflected laser beam LB, is scanned on the photosensitive surface of the drum 4 in the main scanning direction at a constant speed.

Meanwhile, the laser beam LB is scanned on the photosensitive surface also in the auxiliary scanning direction (direction V) by rotating the photosensitive drum 4 about the rotation axis 4a.

A mirror 5 is placed at a position outside a drum scan range (range for the main scan of the laser beam LB on the photosensitive drum 4) in order to receive and reflect the laser beam LB at the beginning of each main scanning. The laser beam LB reflected by the mirror 5 is received by a photodiode 12 as a photodetector, by which a scan timing signal (indicating the scan timing of the laser beam LB in the main scanning direction) and a misalignment detection signal (indicating the misalignment of the laser beam LB in the auxiliary scanning direction) are obtained.

Incidentally, the term “main scanning direction” in this document means not only the direction H parallel to the rotation axis 4a of the photosensitive drum 4 but also any equivalent direction regarding the main scanning of the laser beam LB, that is, any direction in which the laser beam moves according to the main scanning. The main scanning direction can change when the dynamically deflected laser beam is further deflected or reflected (by the mirror 5, etc.), and a “main scanning direction” different from the direction H may be defined at the photodiode 12 (photodetector), for example. The “auxiliary scanning direction” is also defined similarly at any point on the optical path of the laser beam LB, as a direction (corresponding to the auxiliary scanning direction V on the photosensitive drum 4) orthogonal to the main scanning direction.

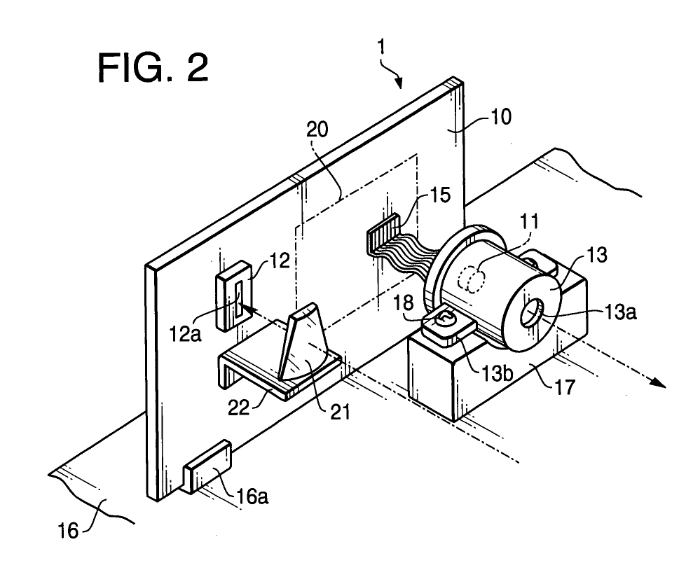

The laser diode 11 (as the laser source) and the photodiode 12 (as the photodetector) are mounted on the same circuit board to form a light source unit 1. FIG. 2 is a perspective view showing an example of the composition of the light source unit 1 which is built up on a circuit board 10. The circuit board 10, formed as a rectangular wiring board and provided with a necessary wiring pattern, is held vertically in landscape orientation by supports 16a which are attached on a base 16 of the laser scanning device 100.

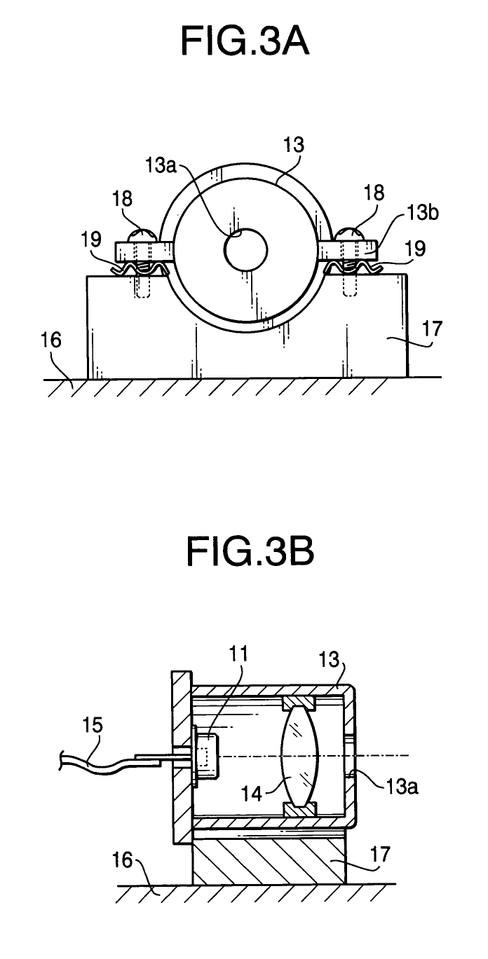

The laser diode 11 is packaged in a cylindrical laser diode casing 13 together with a collimating lens 14, as is also shown FIG. 3A (front view) and FIG. 3B (vertical sectional view). A laser beam emitted by the laser diode 11 is collimated by the collimating lens 14 into a parallel beam and emerges from an exit opening 13a on the top face of the laser diode casing 13. The laser diode 11 is fixed inside the laser diode casing 13 so that the chief ray of the laser beam emitted therefrom will be coaxial with the central axis of the cylindrical casing 13.

The laser diode casing 13 also contains an unshown monitoring photodiode which receives part of the laser beam emitted by the laser diode 11 and thereby detects light intensity of the laser beam. The light intensity detected by the monitoring photodiode is used for controlling output power of the laser diode 11. The output power control of the laser diode 11 can be conducted by an ordinary method and thus detailed description thereof is omitted here.

The laser diode 11 accommodated in the laser diode casing 13 is electrically connected to the circuit board 10 by flexible wires 15 so that laser diode 11 is movable relative to the circuit board 10, while being fixed and supported by a support block 17 which is secured on the base 16 of the laser scanning device. A pair of flanges 13b extend from the laser diode casing 13 to opposite sides, and the laser diode casing 13 is fixed on the support block 17 by a pair of screws 18 that penetrate the flanges 13b. A blade spring 19 is sandwiched between the each flange 13b and the support block 17, and vertical position of the laser diode casing 13 relative to the support block 17 can be adjusted by tightening or loosening the screws 18. By the position adjustment of the laser diode casing 13, the position of the optical axis of the laser diode 11 can be adjusted in the vertical direction (auxiliary scanning direction).

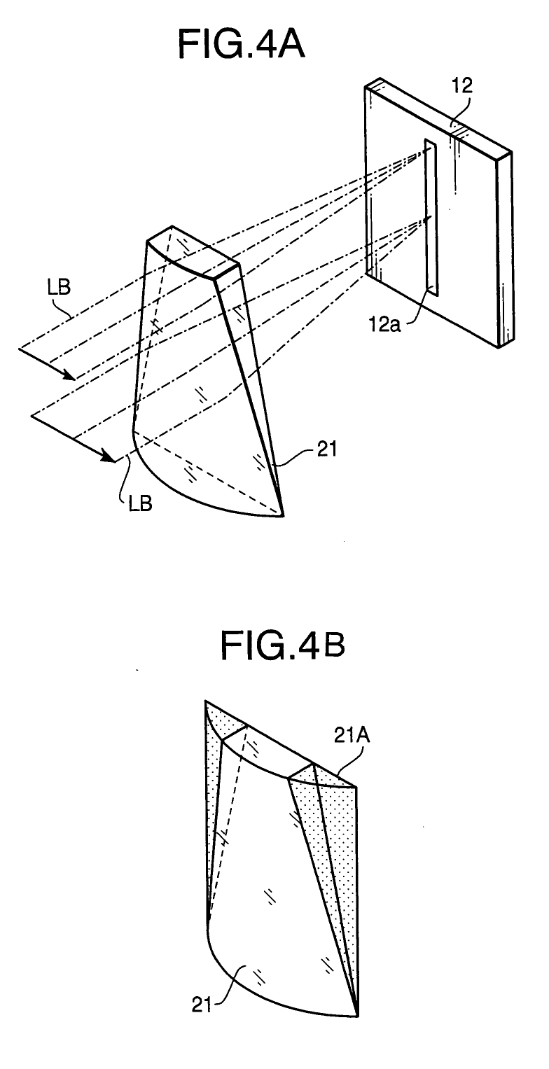

The photodiode 12 is fixed on the circuit board 10 to be a predetermined distance apart from the laser diode 11 in a horizontal direction. As shown in a perspective view of FIG. 4A, the photodiode 12 has a photosensitive surface 12a in a rectangular or slit-like shape extending in the vertical direction (i.e., auxiliary scanning direction). The length of the photosensitive surface 12a in the vertical direction is set long enough to be usable for the adjustment of laser beam alignment (for the elimination of the misalignment) in the auxiliary scanning direction (vertical direction). The photodiode 12, electrically connected to the circuit board 10, outputs an electronic signal to a signal processing circuit 20 on the circuit board 10 when the laser beam is incident on the photosensitive surface 12a.

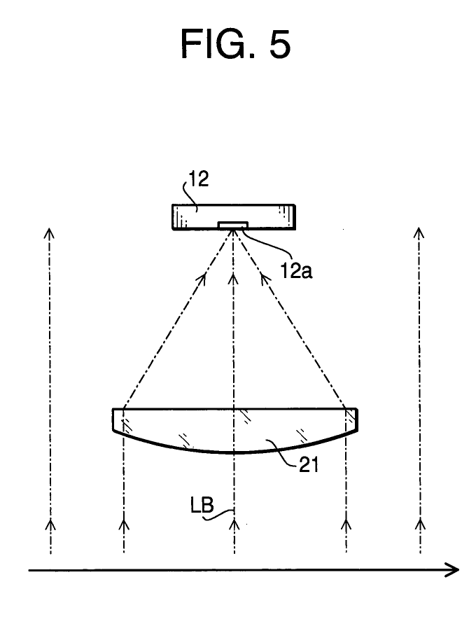

In front of the photosensitive surface 12a of the photodiode 12, a sensor lens 21 is held at a predetermined position by a stem 22 standing on the circuit board 10. The sensor lens 21 is placed at the position for receiving the laser beam reflected by the mirror 5 when the beam is incident thereon, deflecting the incident laser beam while converging it, and thereby projecting the laser beam on the photosensitive surface 12a. The sensor lens 21 is formed in a shape that is cut out of a cylindrical lens 21A as shown in FIG. 4B and is positioned to cover the photosensitive surface 12a so that the central axis of the cylinder is parallel with the extending direction of the photosensitive surface 12a, and its focal point (line) is on the photosensitive surface 12a as shown in FIG. 5. The stippled areas shown in FIG. 4B indicate areas removed from the cylindrical lens 21A for forming the sensor lens 21 shown in FIG. 4A. The length of the sensor lens 21 in the vertical direction (auxiliary scanning direction of the laser beam) is set longer than that of the photosensitive surface 12a. The width of the sensor lens 21 in the horizontal direction (corresponding to the main scanning direction of the laser beam) is tapered off so that the width will be narrower at an upper position and wider at a lower position (like an isosceles triangle when seen along the optical axis direction of the sensor lens 21).

In the laser scanning device composed as above, the laser beam LB emitted by the laser diode 11 and collimated by the collimating lens 14 in the laser diode casing 13 is outputted through the exit opening 13a, dynamically deflected by the revolving polygonal mirror 2, and thereby scanned through the fθ lens 3 on the photosensitive surface of the drum 4 in the main scanning direction as shown in FIG. 1. The laser beam LB is scanned also in the auxiliary scanning direction by the rotation of the photosensitive drum 4 around its rotation axis 4a. By the main scanning and auxiliary scanning of the laser beam LB (which has been modulated according to image data), a desired two-dimensional image (electrostatic latent image) is formed on the photosensitive drum 4.

Just before being scanned on the photosensitive drum 4 in the main scanning direction, the laser beam LB emerging from the fθ lens 3 is incident on and reflected by the mirror 5, and then, received by the photodiode 12. The photodiode 12 outputs a reception signal to the signal processing circuit 20 while it is receiving the laser beam LB. The signal processing circuit 20 generates a reception timing signal (indicating the timing of reception of the laser beam) and also detects the misalignment of the laser beam in the auxiliary scanning direction by use of the reception signal supplied from the photodiode 12. The reception timing signal is generated as a synchronization signal to be used for maintaining synchronization with a video signal which is inputted to the laser scanning device 100. Timing for the main scanning of the laser beam LB (emitted by the laser diode 11) on the photosensitive drum 4 is finely adjusted with use of the video signal synchronized by the synchronization signal. Meanwhile, by the detection of the laser beam misalignment in the auxiliary scanning direction, positioning (alignment adjustment) of the laser diode 11 in the auxiliary scanning direction is made possible.

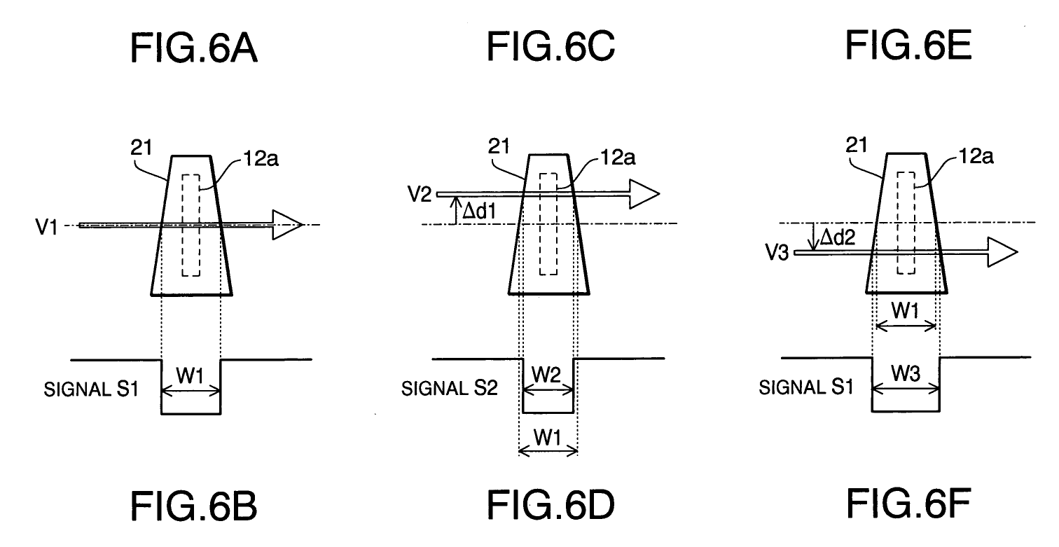

FIG. 5 and FIGS. 6A-6C are diagrams explaining the operation of the photodiode 12 for generating the reception timing signal and detecting the misalignment in the auxiliary scanning direction, in which FIG. 5 shows the sensor lens 21 and the photodiode 12 from above and FIGS. 6A, 6C and 6E show the photosensitive surface 12a (indicated by broken lines) of the photodiode 12 from the front through the sensor lens 21. As shown in FIG. 5, while the laser beam LB being scanned in the main scanning direction (horizontal direction in FIG. 5) is incident on the sensor lens 21, the incident laser beam LB is refracted by the sensor lens 21 in the main scanning direction and proceeds toward the photosensitive surface 12a of the photodiode 12. Thus, the reception signal, as the result of reception of the laser beam LB by the photosensitive surface 12a, is outputted by the photodiode 12 while the laser beam LB scanning in the main scanning direction is incident on the sensor lens 21.

FIGS. 6A-6F are depicting a variety of main scans at different positions in the auxiliary scanning direction. FIG. 6A shows a main scanning in which there is no misalignment of the laser beam LB in the auxiliary scanning direction. In the case of FIGS. 6A and 6B, the laser beam LB before being scanned on the photosensitive drum 4 in the main scanning direction is reflected by the mirror 5 and is scanned on the sensor lens 21 and the photosensitive surface 12a in the horizontal direction at a vertical position V1. Since the laser beam LB incident on the sensor lens 21 is deflected in the main scanning direction to be projected on the photosensitive surface 12a, the photodiode 12 outputs a reception signal S1 while the scanned laser beam LB is within the width WI of the sensor lens 21 at the scan position V1, as shown in FIG. 6B.

Meanwhile, in the case of FIG. 6C where the position of the laser beam LB in the auxiliary scanning direction has shifted upward from the standard vertical position V1 to V2, the photodiode 12 outputs a reception signal S2 while the scanned laser beam LB is within the width W2 of the sensor lens 21 at the scan position V2 (=V1+Δd1), as shown in FIG. 6D. Due to the tapered shape of the sensor lens 21, the signal width W2 of the reception signal S2 is narrower than the signal width W1 of the reception signal S1. Therefore, the upward misalignment Δd1 of the laser beam LB in the auxiliary scanning direction, which is proportional to the signal width difference ΔW=W1−W2, is detected by the signal processing circuit 20.

On the other hand, in the case of FIG. 6E where the position of the laser beam LB in the auxiliary scanning direction has shifted downward from the standard vertical position V1 to V3, the photodiode 12 outputs a reception signal S3 while the scanned laser beam LB is within the width W3 of the sensor lens 21 at the scan position V3 (=V1−Δd2), as shown in FIG. 6F. Due to the tapered shape of the sensor lens 21, the signal width W3 of the reception signal S3 becomes wider than the signal width W1 of the reception signal S1. Therefore, the downward misalignment Δd2 of the laser beam LB in the auxiliary scanning direction, which is proportional to the signal width difference ΔW=W1−W3, is detected by the signal processing circuit 20.

As above, the upward/downward misalignment of the laser beam LB or the laser diode 11 from the standard vertical position (measured in the auxiliary scanning direction) can be detected from the signal width difference ΔW of the reception signal outputted by the photodiode 12. Thus, the position of the laser diode 11 in the auxiliary scanning direction can be corrected precisely by adjusting the height of the laser diode casing 13 by tightening or loosening the screws 18 (fixing the laser diode casing 13 on the support block 17) until the signal width difference ΔW becomes 0.

Meanwhile, by obtaining the central point of the signal width W1-W3 of each reception signal S1-S3 outputted by the photodiode 12, information on the timing of laser beam reception by the photodiode 12 can be obtained as a main scan timing signal. While detailed explanation on the adjustment in the main scanning direction is omitted here, in conventional techniques, the main scan timing of the laser beam LB on the photosensitive drum 4 can be adjusted by changing the laser beam reception timing of the photodiode 12 by properly adjusting the angle of the mirror 5. The laser beam reception timing of the photodiode 12 can also be changed by mounting the photodiode 12 on the circuit board 10 to be movable in the horizontal direction and properly adjusting the horizontal position of the photodiode 12.

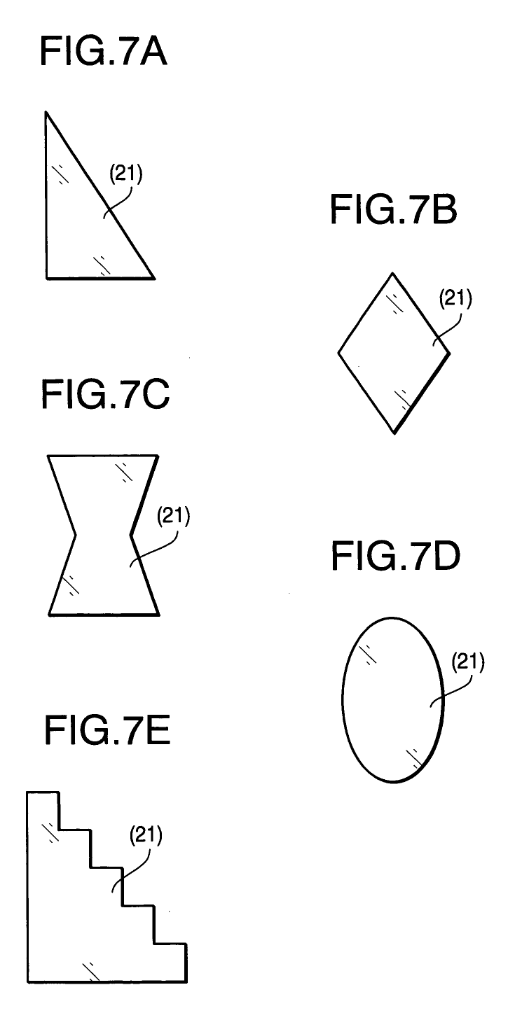

Incidentally, while the sensor lens 21 is formed like an isosceles triangle in this embodiment, the shape of the sensor lens 21 is not limited to the isosceles triangle as long as the width of the sensor lens 21 (measured in the main scanning direction) varies in the auxiliary scanning direction. For example, a right triangle shown in FIG. 7A, a diamond shape shown in FIG. 7B, a hand drum shape shown in FIG. 7C, an elliptical shape shown in FIG. 7D, etc. are also possible. However, symmetry of the shape of the sensor lens 21 in the auxiliary scanning direction (FIG. 7B-7D) makes it difficult to discriminate between upward misalignment and downward misalignment (whether the laser beam LB is above or below the standard vertical position V1). The width of the sensor lens 21 may also be changed stepwise in the auxiliary scanning direction as shown in FIG. 7E.

As described above, in the laser scanning device in accordance with the first embodiment of the present invention, misalignment of the laser beam LB in the auxiliary scanning direction can be detected only by placing a sensor lens having a width (in the main scanning direction) that varies depending on the position in the auxiliary scanning direction, and receives the laser beam scanning in the main scanning direction and converges the received laser beam in the main scanning direction so that the laser beam LB incident on the sensor lens 21 impinges on a photodetector (photosensitive surface 12a) in front of the photodetector. Therefore, the composition of the mechanism for detecting the misalignment of the laser beam in the auxiliary scanning direction can be simplified considerably and thereby downsizing and cost reduction of the laser scanning device are realized.

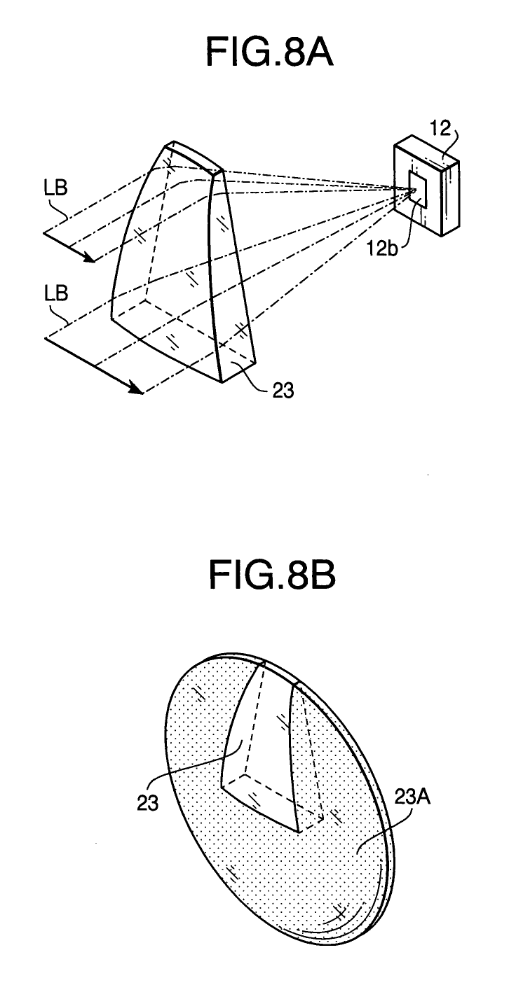

Next, a laser scanning device in accordance with a second embodiment of the present invention will be described referring to FIGS. 8A and 8B. While the sensor lens 21 of the first embodiment is formed as part of a cylindrical lens, other types of lens can also be employed as long as the width of the lens measured in the main scanning direction varies depending on the position in the auxiliary scanning direction and the laser beam at any scanning position is directed toward the photosensitive surface 12a of the photodiode 12. FIGS. 8A and 8B show an example in which a sensor lens 23 is cut out of a simple plano-convex lens 23A. As shown in FIG. 8B, the sensor lens 23 is obtained by cutting an isosceles-triangle-like part from the plano-convex lens 23A along its radius. The sensor lens 23 of the second embodiment also deflects the laser beam LB in the main scanning direction toward a photosensitive surface 12b of the photodiode 12 as shown in FIG. 8A.

Thus, due to the tapered shape of the sensor lens 23, the signal width W of the reception signal S changes depending on the vertical position of the laser beam LB being scanned in the main scanning direction, by which misalignment of the laser beam in the auxiliary scanning direction can be detected. In addition, the sensor lens 23 of the second embodiment refracts the laser beam LB also in the vertical direction (auxiliary scanning direction) as shown in FIG. 8A. Therefore, the photosensitive surface 12b is not required to extend in the auxiliary scanning direction and the photodiode 12 can be downsized considerably compared to the photodiode 12 of the first embodiment.

While each sensor lens described above is cut out of a cylindrical lens or plano-convex lens, a sensor lens having substantially the same function can also be obtained by masking the stippled part of the lens of FIG. 4B or 8B with shielding material. Alternatively, the sensor lens may be formed by a diffraction lens. Further alternatively, a curved mirror having the similar function as the sensor lens 21 or 23 can be used instead of the lens.

While the dynamically deflected laser beam scanned in the main scanning direction is reflected by the mirror 5 to the photodiode 12 in the laser scanning devices described above, the present invention is also applicable to laser scanning devices in which a photodiode is placed to receive the laser beam scanned by the polygonal mirror directly (not via a mirror). In this case, an optical element (prism, etc.) for deflecting the optical axis of the laser beam may be provided between the polygonal mirror and the photodiode in order to guide the laser beam to the photodiode.

While the detection of the misalignment in the auxiliary scanning direction and the generation of the main scan timing signal are both conducted by use of a single photodiode in the above embodiments, separate photodetectors may also be employed for them.

While the present invention has been described with reference to the particular illustrative embodiments, it is not to be restricted by those embodiments but only by the appended claims. For example, the polygonal mirror for dynamically deflecting the laser beam may be replaced with other type of deflection/scanning module such as a galvanometer mirror. It is to be appreciated that those skilled in the art can change or modify the embodiments without departing from the scope and spirit of the present invention.

The present disclosure relates to the subject matter contained in Japanese Patent Application No. 2003-036616, filed on Feb. 14, 2003, which is expressly incorporated herein by reference in its entirety.

What is claimed is:

1. A laser scanning device, comprising:
a laser source which emits a laser beam;
a deflector which dynamically deflects the laser beam emitted by said laser source, the laser beam scanning in a main scanning direction within a predetermined angular area;
a photodetector which receives light and output electronic signal corresponding to the received light; and
a sensor lens arranged to receive the laser beam scanning at a predetermined scanning range, said sensor lens having power at least in the main scanning direction, said sensor lens converging the incident laser beam on said photodetector, said sensor lens having width in the main scanning direction varying in the auxiliary scanning direction.

2. The laser scanning device according to claim 1, wherein said sensor lens is formed to be asymmetrical in the auxiliary scanning direction.

3. The laser scanning device according to claim 2, wherein the width of said sensor lens in the main scanning direction varies stepwise depending on a position in the auxiliary scanning direction.

4. The laser scanning device according to claim 2, wherein the width of said sensor lens in the main scanning direction varies continuously depending on a position in the auxiliary scanning direction.

5. The laser scanning device according to claim 4, wherein said sensor lens is formed in a triangle-like shape whose oblique sides are tilted in the main scanning direction relative to a photosensitive surface of said photodetector.

6. The laser scanning device according to claim 1, wherein said sensor lens converges the laser beam only in the main scanning direction on said photodetector.

7. The laser scanning device according to claim 6, wherein said sensor lens is formed as a part of a cylindrical lens.

8. The laser scanning device according to claim 6, wherein said photodetector has a light receiving area elongated in the auxiliary scanning direction.

9. The laser scanning device according to claim 8, wherein a length of the light receiving area of said photodetector in the auxiliary scanning direction is substantially equal to the length of said sensor lens in the auxiliary scanning direction.

10. The laser scanning device according to claim 1, wherein said sensor lens converges the laser beam both in the main scanning direction and in the auxiliary scanning direction on said photodetector.

11. The laser scanning device according to claim 10, wherein said photodetector has a light receiving area elongated in the auxiliary scanning direction.

12. The laser scanning device according to claim 11, wherein said photodetector has a light receiving area whose length in the auxiliary scanning direction is shorter than the length of said sensor lens in the auxiliary scanning direction.

13. The laser scanning device according to claim 11, wherein said sensor lens converges the laser beam on a substantially predetermined position regardless of a position of the incident laser beam.

14. The laser scanning device according to claim 13, wherein said sensor lens is formed as a part of a convex lens.

15. The laser scanning device according to claim 13, wherein said photodetector has a light receiving surface which is arranged to receive only the laser beam converged on the predetermined position.

16. The laser scanning device according to claim 1, wherein said photodetector also serves as a photodetector for outputting a main scanning timing signal which indicates timing of main scan of the laser beam in the main scanning direction.

17. The laser scanning device according to claim 1, wherein said laser source is mounted on said laser scanning device so that position of its optical axis can be shifted in the auxiliary scanning direction.
